(19) United States
(12) Patent Application Publication
(10) Pub. No.: US 2024/0354785 A1
(43) Pub. Date: Oct. 24, 2024

(54) FEATURE ADDITION ANALYSIS FOR AN ITEM

(71) Applicant: Disney Enterprises, Inc., Burbank, CA (US)

(72) Inventors: Fabian Gallusser, Palo Alto, CA (US); Huancen Liu, New York City, NY (US); Everett Sussman, New York City, NY (US); Dwight Liu, San Francisco, CA (US)

(73) Assignee: Disney Enterprises, Inc., Burbank, CA (US)

(21) Appl. No.: 18/305,197

(22) Filed: Apr. 21, 2023

(51) Int. Cl. G06Q 30/0202; G06Q 10/0631; H04N 21/81

(52) U.S. Cl. CPC G06Q 30/0202; G06Q 10/06315; H04N 21/8106

(57) ABSTRACT

In some embodiments, a method receives a first instance of the item. Also, information for changes in a metric is received that is based on a delayed release time of a feature for second instances of the item after the second instances of the item were released. The method selects a second instance of the item from the second instances of the item based on a relationship to the first instance of the item. A second change in the metric is estimated for the first instance of the item based on a first change in the metric from the second instance of the item that is selected. Then, the method generates a ranking score for the feature if the feature is released for the first instance of the item based on the second change in the metric.

### BACKGROUND

A service may have options to add a feature to an item. For example, a content delivery service may release content as an item that can be played back by users. In some examples, a movie or show may be released. That movie or show may be associated with a first language as a feature, such as the content may have an audio track in English and subtitles in English. However, audio or subtitles for other languages as features that may also be released for the content, such as French, Korean, etc. To release the content with a new language, the audio track or subtitles need to be translated into the new language.

There may be advantages to releasing the content in another language. For example, releasing the content in another language may result in additional user accounts that playback the content, such as user accounts that may decide to playback the content in the new language, but may not have played back the content in the first language. However, the translation to the new language may incur cost, such as in manual hours to generate a translation of the audio track or subtitles, computing resources to generate a machine translation, hiring local celebrities or local actors to dub the audio, etc. Even if a machine translation is used, the machine translation may not be adequate because the translation may need to be validated by a human user. In addition, different languages may have other idiosyncrasies that require some adjustment of the language by a human user. Also, there may be no guarantee that a release in the new language may result in an increase in viewership. For example, a translation of the content into another language may not result in a large increase in viewership and the cost of the translation may not be justified.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 depicts a simplified system for estimating a change of a metric of interest and ranking features according to some embodiments.

FIG. 2 depicts a simplified flowchart of a method for building a dictionary according to some embodiments.

FIG. 3 depicts a graph for a metric of interest according to some embodiments.

FIG. 4 depicts an example of a graph that models the metric without the effect of the feature after the event according to some embodiments.

FIG. 5 depicts a graph that estimates the metric of interest before the release of the feature according to some embodiments.

FIG. 6 depicts a graph of estimated effect before and after the release of the feature according to some embodiments.

FIG. 7 depicts an example of a dictionary that is stored in repository according to some embodiments.

FIG. 8 depicts a simplified flowchart of a method for ranking features according to some embodiments.

FIG. 9 illustrates one example of a computing device.

### DETAILED DESCRIPTION

Described herein are techniques for a content analysis system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system may rank an addition of one or more features to an item. An item may be offered for consumption by a service. The feature may be associated with the item and multiple features may be interchangeably associated with the item. The following will describe the addition of language as a feature to a release of content as an item in an example; however, the feature may be added in other scenarios. In some embodiments, different means of engaging with content may be evaluated, such as evaluating whether to add closed captioning versus subtitles, adding an audio description (an accessibility options for hard of sight) versus regular audio, or other forms of interaction with content such as haptics or other add-ons, etc. Also, outside the engagement with content, other features may be evaluated including features that may cause a lift in interest of the item. For example, the features may be related to hotels, such as languages to offer to guest; parks, such as line waiting features, different options for engaging with rides in parks, anything that requires a cultural preference, anything that requires a translation of a language or other information, etc. Further, the ranking may be used any time there may be options to introduce languages to an item, such as whether to translate languages for content offered in parks, cruises, websites, etc.

To generate a ranking, a system may leverage an addition of a feature to generate a model for estimating a metric of interest over time. The metric of interest may be different metrics, such as a number of hours streamed, a number of accounts that playback the content, a number of riders, etc. The number of hours streamed may be based on an amount of hours played back for content for all features (e.g., all languages). In some examples, content may be released with an audio track in a first language, such as English. At some later point in time, a new audio track in a new language may have been released after the first language was released. For example, at day 30, a second audio track in a second language is released for the content. The metric of interest may be measured in a time series over a time period, such as hourly, daily, weekly, etc. The system may determine a change in a metric of interest that results due to the release of the second language. For example, if the metric of interest is a number of hours streamed, the system may model a change in the metric that may be attributed to the second language. That is, the system may estimate that the release of the content in the second language may result in an effect of an increase of 10% of hours streamed. The system can estimate the effect in the hours streamed due to the addition of different languages for multiple instances of content, such as via a delayed release. As will be described below, if a first language and a second language were released together, attributing the additional hours streamed to the second language may be hard because separately which user accounts streamed the content because the second language was released cannot be determined. With the information, the system may generate a dictionary that includes information for different instances of content, languages, and the effect that were modeled.

When considering a new instance of content (e.g., content that is going to be released), the system may analyze features that could be added and rank the features. In some embodiments, the system may analyze languages that could be added and generate ranking scores for the languages. In some embodiments, the ranking scores may be used to determine which languages to translate the content into before the release of the content.

To generate the ranking, a system may determine other instances of content in the dictionary that may be related to the new instance of content. For example, if a sequel to a movie is being released, then information from a prior movie in the series may be retrieved from the dictionary. Also, other movies that may be in the same genre may also be retrieved or the use of a knowledge graph that determines content similarity may be used. The system may use the effect of adding a feature that was estimated for the other instances of content to determine an estimated effect of adding the feature for the new instance of content. For example, the change in hours streamed for the new instance of content may be estimated for the languages of Korean, French, and Japanese based on changes that occurred for related instances of content. The system may generate a ranking score for the languages. Then, the system can determine which languages to translate the content into based on the ranking scores. For example, if translating the content into Korean may result in a 20% change in hours streamed, then the ranking score may be high. But, if translating the content into French results in a very small increase in hours streamed, then the language of French may be ranked lower. The estimated change in hours streamed may allow a more accurate decision on which languages to translate the content into before releasing the content, or at a later time.

The calculation of the effect on the metric of interest may be improved. In some embodiments, the change in hours streamed is estimated based on content in which a second language was released after a first language was released for the content. This allows the system to generate a more accurate change in the hours streamed. That is, if the second language was released at the same time as the first language, then the increase in hours streamed due to releasing the second language may be hard to estimate because both languages were released on the same day. However, after receiving hours streamed for the first language for a certain number of days, such as 30 days, and then releasing the second language, the increase in hours streamed due to the release of the second language may be better estimated. For example, the increase in hours streamed on day 30 when the second language is released may be more accurately attributed to the release of the second language because this is a new event that occurs on day 30. Also, the data received after day 30 may also be used to determine the change in hours streamed. For example, the system may estimate what the hours streamed would have been had the second language not released at day 30 going forward using the measured data from before day 30 for the first language. Then, the change in viewership going forward from day 30 is based on a difference between the estimated value of hours streamed for the first language and the measured value of hours streamed for the first language and the second language. Additionally, in another improvement, the system may estimate the change in hours streamed backwards from day 30 if both the first language and the second language were released using the measured data from day 30 onward. For example, the system may estimate what the hours streamed would have been if the second language had released at day 1 going forward, and the change in viewership going forward from day 1 is based on a difference between the estimated value of hours streamed for releasing both the first language and the second language on day 1 and the measured value of hours streamed for only releasing the first language. This provides a change for the entire time period from day 1 to day X. Accordingly, the use of a forward modeling and a reverse modeling provides more meaningful insights into the calculation of the change because the change before the release and after the release is used instead of just after the release. A technical improvement is also provided because a calculation can be performed faster using the dictionary of content with the associated effect on the metric of interest. Instead of calculating the effect based on characteristics of different content, the dictionary may be used to generate the effect faster and also using fewer computing resources.

In some examples, the metric of interest may not be able to measure the effect of the release of the feature. For example, there could be cannibalization when the release of a feature occurs on another feature. If content is released in English, and then Spanish, some users will prefer watching in Spanish but if unavailable will watch in English. So, if 100 hours are streamed daily in English, when the Spanish language version becomes available, the number of hours in English might dip because of that, and the system may observe 90 hours instead of 100 hours in English, and total hours will be 110 (+10%). Also, the system may not be able to determine which language was used when playing back the content. That is, the audio track that is used when playing back the content may not be received by the system. The metric of total hours streamed is received, however, and the system can estimate the effect of releasing the content using the second language.

### System

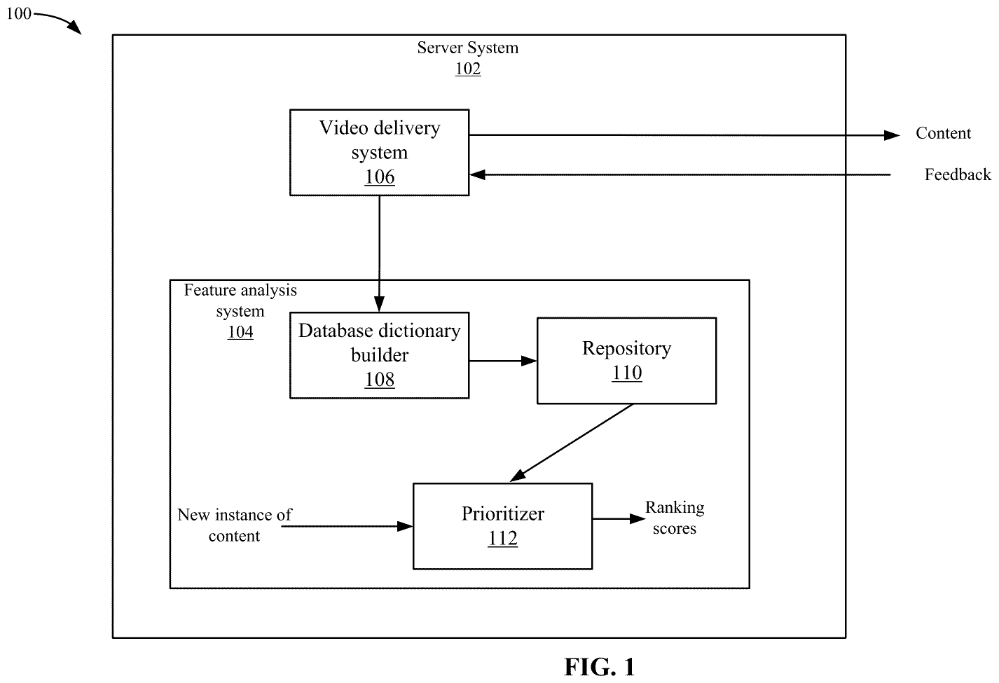

FIG. 1 depicts a simplified system 100 for estimating a change of a metric of interest and ranking features according to some embodiments. A server system 102 includes a feature analysis system 104 and a video delivery system 106.

Video delivery system 106 may provide content for playback to client devices (not shown). Although the playback of content is described, other items may also be provided as was discussed above. Feedback may be received based on the playback of the content. In some embodiments, the feedback may be information on an amount of time of playback of the content by client devices. Other feedback may also be received, such as a number of client devices or user accounts that played back the content, etc. If other items are being used, the feedback may be the number of guests that ride certain rides over time, visits to a website, etc.

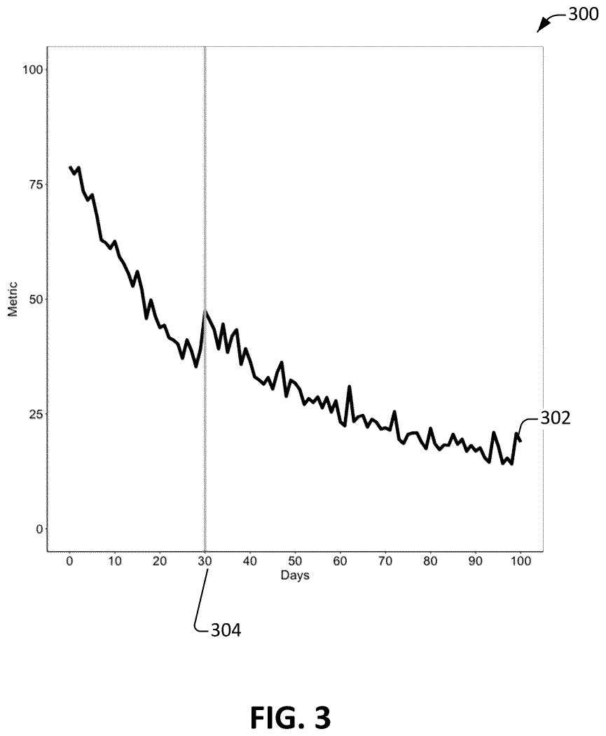

Feature analysis system 104 receives the feedback from video delivery system 106. A database dictionary builder 108 may build a dictionary based on the feedback. For example, the dictionary may include information for an effect on a metric of interest. The metric of interest may be based on information for the item, such as for a release of all available features. The release may be where a feature is available, such as the content can be played back using a released language. In some embodiments, the metric may be the number of hours streamed over time for an instance of content for all available features. For example, for a movie #1, the number of hours streamed per day may be received over time. Database dictionary builder 108 may analyze the feedback to determine a change in the metric of interest based on an event, such as the release of an instance of content with a new language as an audio track. In some embodiments, for identified instances of content in which an event occurs, database dictionary builder 108 determines the change in the metric of interest that may be due to the release of the instance of content with the new language. In some embodiments, an event may be the release of the content in a new language after the release of the content in a first language. If the metric of interest is the number of hours streamed of the content, then database dictionary builder 108 may determine the change in the number of hours streamed that can be attributed to the addition of the new language. The process of determining the change will be described in more detail below starting in FIG. 3.

Database dictionary builder 108 may analyze multiple instances of content in which an event occurred and store information in repository 110. In some embodiments, the information stored in repository 110 may list the instance of content, a country in which a language was added, the language, and also an effect of adding the language in the country that was estimated. Although this information is described as being stored, other information may be stored for an instance of content. In other embodiments, instead of a country, a different geographical boundary may be used, such as a region, such as Asia-Pacific that includes multiple countries. Also, other information may be stored, such as a genre, total hours streamed in a country, etc.

A prioritizer 112 may receive a new instance of content and determine a ranking score for different features. In some embodiments, prioritizer 112 may rank different languages based on the effect on the metric for the languages. In some examples, prioritizer 112 may rank the languages based on the effect on the number of hours streamed that could occur if the instance of content is translated into the respective languages and released, such as with an initial release of the first language of the content. The calculation of the ranking scores and ranking will be described in more below.

The following will now describe the dictionary building method and the prioritization method in more detail.

### Dictionary Building

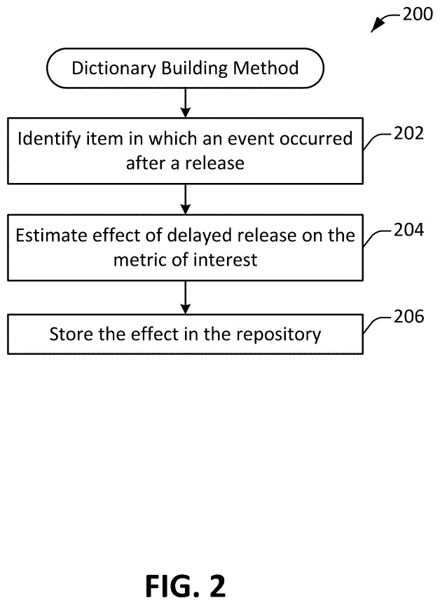

The dictionary building process may be ongoing and can be updated, such as when events for new items are detected or additional measured data from existing item is received. The size of the dictionary may be very large considering the large number of items that may be released, such as content for a content delivery system. For example, the size may include tens of thousands of entries for items, which continually increases as new items are released. The number of items may make it not practical for a human user to build and analyze a dictionary. FIG. 2 depicts a simplified flowchart 200 of a method for building a dictionary according to some embodiments. At 202, database dictionary builder 108 identifies an item in which an event occurred after a release. As discussed above, items with a delayed release of a feature may provide information that can be used to estimate an effect of a change that may be attributed to the feature, and whether the outcome was positive or negative, or no effect. In some embodiments, the item may be an instance of content, the event may be a delayed release of a language in which the content was translated, and the metric of interest is the hours streamed of the content. Video delivery system 106 may release its content with the delayed release of a translation of a first language to a new language. For example, as discussed above, a movie may be released on day 1 in English, and then on day 30, the movie is released in Korean. In some embodiments, database dictionary builder 108 may analyze metadata for the video delivery system 106 to identify when content is released with a new language after the release of the content in another language on the video delivery system 106. For example, metadata may list release dates for new languages.

Upon identifying the content, at 204, database dictionary builder 108 estimates the effect of adding a feature. The effect of adding the feature may be based on a change in a metric of interest that is attributed to the feature that was released with a delay. If the metric of interest is a number of hours streamed, database dictionary builder 108 may estimate the effect of the added feature on the hours streamed. For example, if the content with the new language is released at day 30, database dictionary builder 108 may estimate the effect by the increase in the number of hours streamed that occurs and can be attributed to the release of the feature. An estimation of the effect of the feature may be based on a time period after addition of the feature (e.g., after the delayed release), a time period before the addition (e.g., before the delayed release), or a time period in combination of before the addition and after the addition. FIGS. 3-6 will describe examples of performing the estimation of the effect of the addition of feature based on a delayed release. At 206, database dictionary builder 108 stores information for the instance of content and the associated effect due to the addition of the feature in repository 110.

The following will now describe the estimation of the effect of the delayed release of a feature. FIG. 3 depicts a graph 300 for a metric of interest according to some embodiments. In this example, a value of the metric of interest of a number of hours streamed is shown on the Y-axis, and time is shown on the X-axis. A line 302 shows the number of hours streamed over time. Data that is measured from feedback of streaming the content may be used to generate line 302.

At 304, an event occurs, such as an addition of a feature (e.g., the delayed release of the content with the new language). On day 30, an increase in the number of hours streamed is shown. Database dictionary builder 108 may estimate the effect of the release of the new language. However, estimating the effect after the release on day 30 is performed using a model of a number of hours streamed after day 30 without the release of the new language to predict the effect after day 30. Also, database dictionary builder 108 may model the number of hours streamed before day 30 as if the release of the new language occurred before day 30 to estimate the effect of the release of the new language.

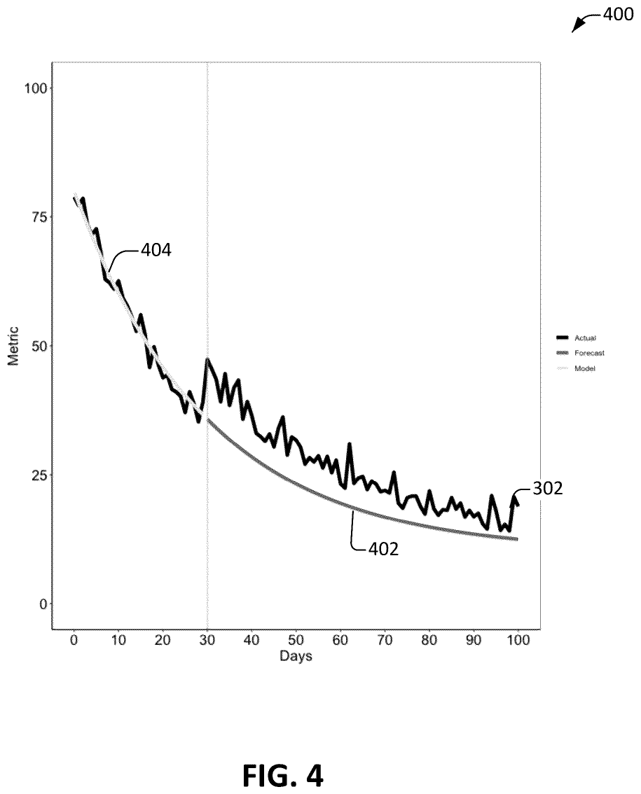

FIG. 4 depicts an example of a graph 400 that models the metric without the effect of the feature after the event according to some embodiments. At 402, the number of hours streamed is estimated as if the release of the new language did not occur. In some embodiments, at 404, database dictionary builder 108 may generate a model based on the number of hours streamed from the data that was received before day 30. This is based on the actual number of hours streamed before the new language was released. Different techniques may be used to build the model, such as using the actual data to model the behavior over time. Then, database dictionary builder 108 may use the model to predict the number of hours streamed without the release of the new language, which is shown at a line 402 after the release date. In some embodiments, the model may be generated with data without the release of the new language and the model is used to predict the number of hours streamed without the release of the new language after day 30. The difference between line 402 and line 302 after day 30 may be used to determine the effect of the release of the new language. That is, line 402 models the number of hours streamed without the release of the new language and line 302 is the number of hours streamed with the release of the new language and the first language. The difference between the two values may be used to determine the effect of the release of the new language from day 30. In some embodiments, database dictionary builder 108 may determine the difference between values in intervals, such as at each day. Then, database dictionary builder 108 may determine an average over time for the effect. Other methods may also be used, such as a median of values, a sum of the difference, etc.

Using the effect from day 30 may be an underestimate of the effect. For example, if the new language had been launched earlier, such as during the initial launch of the first language, there may have been more hours viewed after the initial launch. This may be because after the initial launch, there may be a larger interest in the content due to it being new. This may lead to a larger number of hours streamed in the beginning. As can be seen by lines 302, 402, and 404, the number of hours streamed generally decays over time.

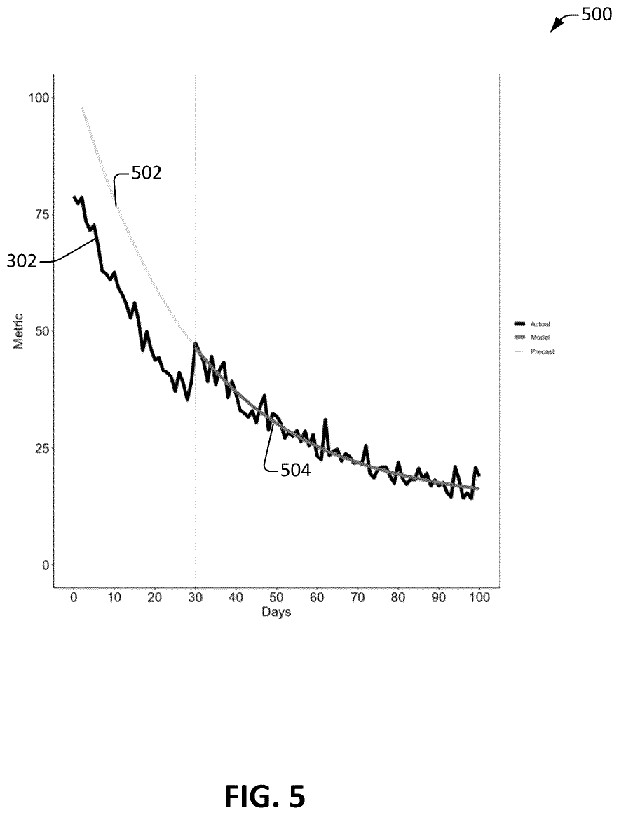

Database dictionary builder 108 may estimate the number of hours streamed before the release of the feature at day 30 to improve the calculation of the effect. FIG. 5 depicts a graph 500 that estimates the metric of interest before the release of the feature according to some embodiments. At 502, database dictionary builder 108 estimates the number of hours streamed before day 30 if both the first language and the second language were released. Database dictionary builder 108 may generate the estimate in different ways. In some embodiments, database dictionary builder 108 may generate a model based on the number of hours streamed after the release of the feature on day 30 using the actual data from line 302, which is based on a line 504. Using that model, database dictionary builder 108 can estimate the number of hours streamed before day 30 as line 502. For example, the model using actual data of the number of hours streamed when the new language and the first language were released after day 30 may be used to predict the number of hours streamed if the new language and the first language were released together from day 1 to day 30.

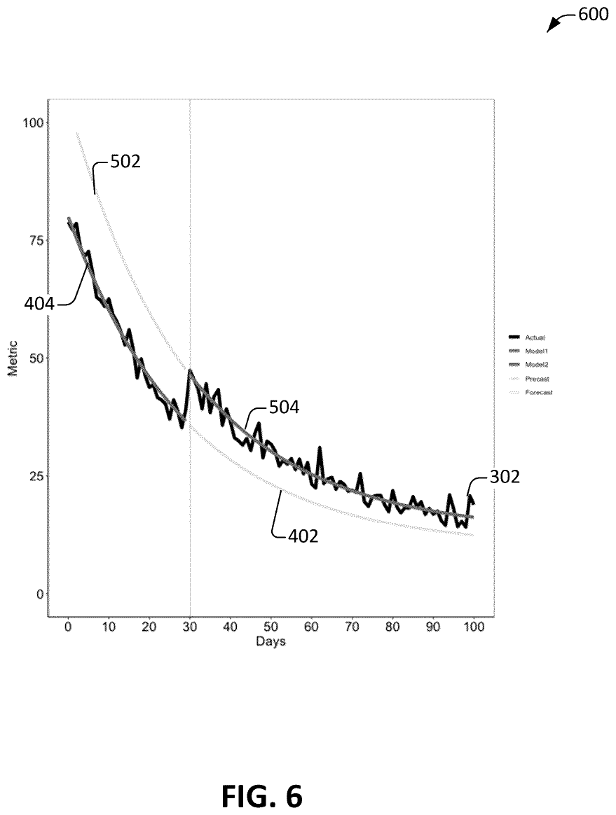

FIG. 6 depicts a graph 600 of estimated effect before and after the release of the feature according to some embodiments. Given line 502, database dictionary builder 108 can estimate the effect of the release of the new language prior to day 30. In some embodiments, a line 402 represents the number of hours streamed with the first language based on the actual data from line 302. Then, database dictionary builder 108 may use a difference between line 404 and line 502 before day 30 to generate the effect of the new language prior to day 30.

The effect of the release of the feature may be based on both a combination of both of the above estimates, only one of the estimates, portions of the estimates, etc. The estimated effect may be based on the two differences before and after the event. For example, database dictionary builder 108 may estimate the effect based on differences between lines 502 and 404 and the differences between lines 402 and 504.

The effect may be quantified using different values, such as a percentage that is determined based on an average difference over time, a total number of the increase of hours streamed, etc. For example, the effect may be a 10% increase, an estimate of 10 million additional hours streamed, etc.

The above estimation was based on two languages being released. However, it is possible that multiple languages (e.g., three or more) are available at the same time. This may make modeling more difficult, and the estimations cannot be performed manually given the complexity. Also, the analysis may consider the added features for a large number of items, which cannot practically be analyzed manually. Additionally, the above examples may have been simplified, but the modeling may use many factors that would not be possible to consider manually in combination. There may be multiple different possibilities of estimating the effect and the model may automatically select optimal possibilities.

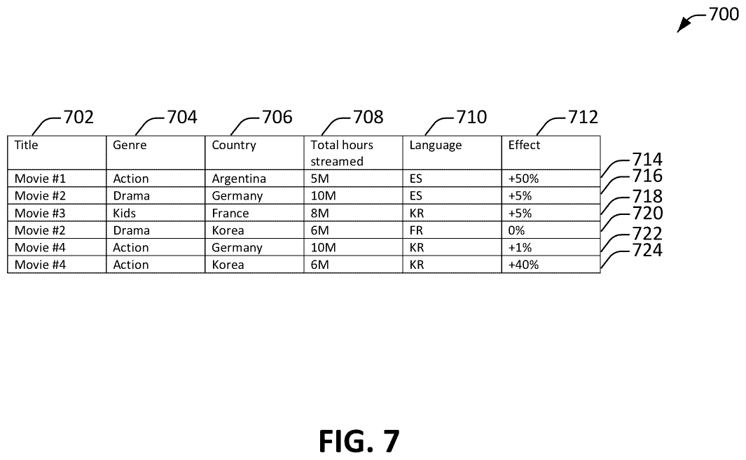

Database dictionary builder 108 builds a dictionary of the effect of new releases of languages for multiple instances of content in repository 110. FIG. 7 depicts an example of a dictionary that is stored in repository 110 according to some embodiments. A table 700 may store entries in rows of the respective table. An entry may be related data for an effect of feature. Although rows are described as entries, the data may be stored in different ways, such as in multiple rows, columns, an index, etc. At 702 to 712, columns may store information for a title, a genre, a country, a total number of hours streamed, a language, and an effect. The title 702 may be a descriptive title for the content, the genre 704 may describe the genre associated with the content, the country 706 may be where the content was released, the total number of hours streamed 708 may be the total amount of hours that is streamed in the country for all instances of content, the language 710 describes the language in which the content was released, and the effect 712 describes the effect of adding the content with the language in the country. For example, at 714, a movie #1 was released in Argentina in Spanish and the estimated effect is an increase of 50% of hours streamed. Also, at 716, a movie #2 was released in Germany in Spanish and the estimated effect is an increase in 5% of hours streamed.

Entries may be associated with a new language that is released. Different entries may be associated with different titles. For example, an entry 714 is associated with a movie #1 and an entry 716 is associated with a movie #2. Also, there also may be multiple entries for the same movie, such as entries at 716 and 720 are for the same movie #2 because multiple new languages were released for movie #2. For example, movie #2 may have been released in different languages of Spanish at 716 and French at 720.

Prioritizer 112 may use the information from repository 110 to generate ranking scores for a new instance of content.

### Prioritization

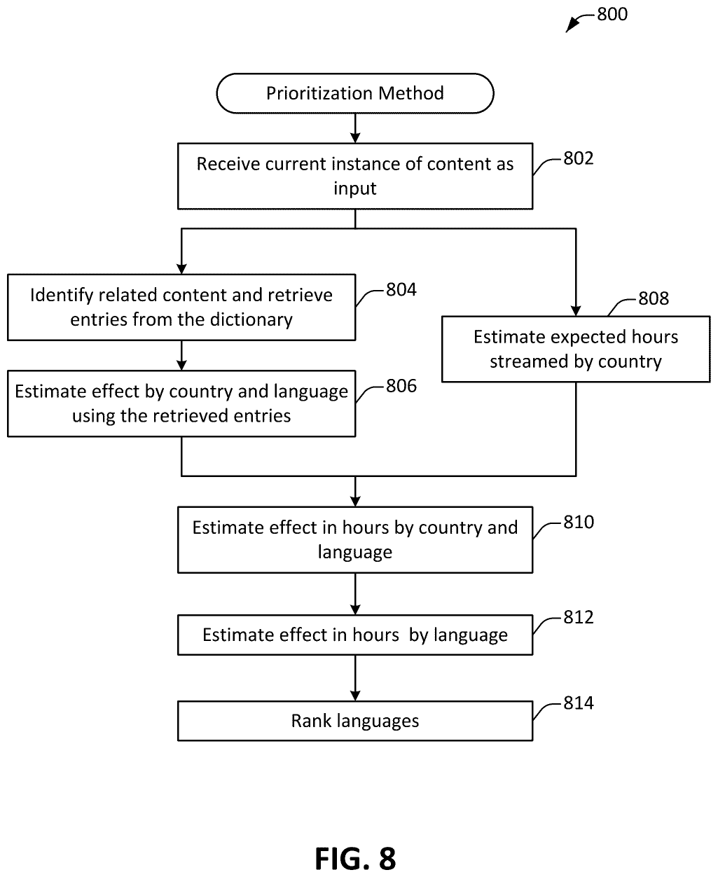

FIG. 8 depicts a simplified flowchart 800 of a method for ranking features according to some embodiments. The method will be described with respect to languages and content, but the effect may be used differently to rank other types of features. In other embodiments, the effect of translating content into different languages at a park may be measured.

At 802, prioritizer 112 receives a current instance of content as input. The current instance of content may be an instance of content that is going to be released, such as a new movie that is going to be initially released on video delivery system 106. The new movie may be associated with a first language, such as an English audio track and/or English subtitles. Video delivery system 106 may want to determine which languages to translate the original language into based on a ranking of the effect of releasing the content in different languages.

At 804, prioritizer 112 identifies related instances of content to the current instance of content and retrieves entries from the dictionary in repository 110. Different methods of analyzing the characteristics of the current instance of content and other instances of content to determine related content may be used. In some examples, if the current content is a sequel, the related content may be the first in the series or another installment in the series. Also, related content may be content that is found within the same genre of the current content. For example, the related content may be within an action genre. Other characteristics may be used, such as a similar country, similar content, similar delays in release dates, etc. Also, prioritizer 112 may use a knowledge graph that may link instances of content based on similar characteristics being associated with instances of content. Prioritizer 112 may find related instances of content that are linked to characteristics of the current instance of content.

Once determining the related content, prioritizer 112 estimates the effect by country and language using the retrieved entries. The estimated effect by country and language may be based on the percentages provided in column 712 of FIG. 7. For example, if entries for movie #4 are retrieved, a first entry lists the country is Korea, the language is Korean, and the effect is +40%. And, for a second entry at 722, the country is Germany, the language is Korean, the effect is +1%. If there are more than one entry for a country and a language, prioritizer 112 may combine the entries, such as averaging the effect from multiple entries for a country.

At 806, prioritizer 112 estimates the effect of hours watched by country and language. A total hours streamed by country may be used to estimate the effect of hours streamed by country and language. For example, the number of hours streamed by country may vary, such as one country may stream a much larger number of hours than another country. The country that streams a much smaller number of hours may have a smaller effect that is estimated. Therefore, at 808, prioritizer 112 may determine the total hours streamed by country from column 708 in FIG. 7.

At 810, prioritizer 112 estimates the effect in hours streamed by country and language. If the effect of translating the current instance of content into a Korean language is being used, an entry at 718 for movie number #3, and entries at 722 and 724 for movie #4 may apply. In this case, in Germany, the 1% effect on a number of hours streamed of 10 million may be a total of 0.1 million hours. Similarly, the effect of adding Korean in Korea may have a 40% effect on a number of hours streamed of 6 million, which is a change of 2.4 million hours. In France, the effect of adding Korean may have a 5% effect on an 8 million hours streamed for a change of 0.4 million hours. Even though entries at 718, 722, and 724 may be used above, not all entries may be relevant. For example, entries at 722 and 724 may be relevant because the current movie is in the same genre as movie #4 of Drama or Action. However, the movie genre for movie number #3 is kids and may not be relevant to the genre of the current instance of content. This entry may not be used in some examples.

At 812, prioritizer 112 estimates the effect in hours per language. In the above, example, there may be an estimate of a 2.9 million hours increase in hours stream if the instance of content in Korean is released. Although the example only used a couple countries and languages, entries for a large number of countries may be used. Also, the number of hours may be estimated differently, such as by the number of hours streamed by country. The estimate may be for the countries in which the language was added. Also, the estimate may be scaled based on a wider release in additional countries, or fewer countries. The above calculation may be performed for multiple languages. For example, the effect of the language of Spanish and French may also be calculated. In some examples, the number of hours streamed if the current instance of content is released in Spanish may be 2.9 million hours streamed, and the number of hours streamed if the current instance of content is released in French may be zero hours streamed.

Then at 814, prioritizer 112 ranks the languages. In some embodiments, prioritizer 112 ranks the languages based on associated increases in hours streamed. In an example that uses all entries of table 700 (which may not be the case always), the Korean language may have an effect of an increase of 2.9 million hours streamed, Spanish may have an effect of an increase of 3.0 million hours streamed, and French is zero. The ranking may be in the order of Spanish, Korean, and French. Although the above may rank languages for all the countries, languages may be ranked per country. That is, different granularities may be used to generate the rankings. For example, the ranking may be based on translating and releasing the current movie in Korean in Korea, Germany, and other countries, instead of releasing the current instance of content in all countries.

### Conclusion

Accordingly, the effect of a feature for an item may be determined. The use of the release of the feature after the initial release of the item may be used to estimate the effect of the feature for a new item. The estimation of the effect from a later released feature may provide a more accurate model to use because actual effects may be observed. Then, the model is used to generate an estimate of the effect of the feature at the initial release.

### System

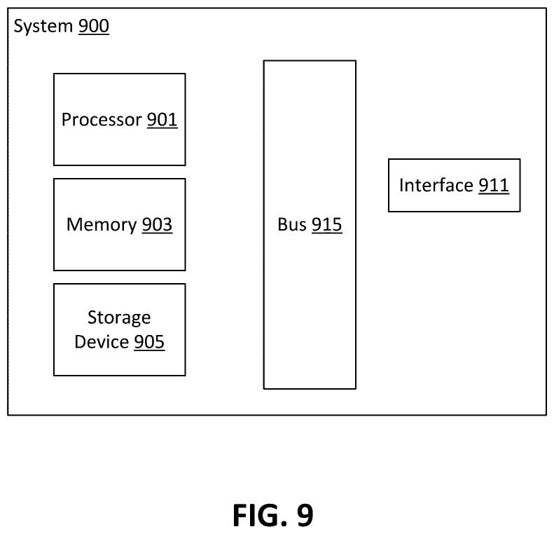

FIG. 9 illustrates one example of a computing device. According to various embodiments, a system 900 suitable for implementing embodiments described herein includes a processor 901, a memory module 903, a storage device 905, an interface 911, and a bus 915 (e.g., a PCI bus or other interconnection fabric.) System 900 may operate as variety of devices such as server system 102, or any other device or service described herein. Although a particular configuration is described, a variety of alternative configurations are possible. The processor 901 may perform operations such as those described herein. Instructions for performing such operations may be embodied in the memory 903, on one or more non-transitory computer readable media, or on some other storage device. Various specially configured devices can also be used in place of or in addition to the processor 901. The interface 911 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C. HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving, by a computing device, a first instance of an item;
receiving, by the computing device, information for changes in a metric based on an addition of a feature for second instances of the item after the second instances of the item were released;
selecting, by the computing device, a second instance of the item from the second instances of the item based on a relationship to the first instance of the item;
estimating, by the computing device, a second change in the metric for the first instance of the item based on a first change in the metric from the second instance of the item that is selected; and
generating, by the computing device, a ranking score for the feature if the feature is released for the first instance of the item based on the second change in the metric.

2. The method of claim 1, wherein:
the first instance of the item is an item that has not already been released, and
the second change in the metric is based on adding the feature on an initial release of the first instance of the item.

3. The method of claim 1, wherein the feature comprises a first feature, and wherein the information for changes in the metric based on the addition of the feature for a second instance of the item is determined by:
receiving first information for the metric after a release time based on the release of the second instance of the item with a second feature and the first feature;
receiving second information for the metric based on the release of the second instance of the item with the second feature before the release time; and
estimating a third change in the metric for the first feature after the release time based on the first information and the second information wherein the third change is used to determine the first change.

4. The method of claim 3, wherein estimating the third change in the metric after the release time comprises:
generating a model based on the release of the second instance of the item with the second feature and not the first feature before the release time; and
estimating third information for the metric after the release time based on the release of the second instance of the item with the second feature and not the first feature.

5. The method of claim 4, wherein estimating the third change in the metric after the release time comprises:
using a difference between the third information and the first information to estimate the third change in the metric after the release time.

6. The method of claim 1, wherein the feature comprises a first feature, and wherein the information for changes in the metric based on the addition of the feature for a second instance of the item is determined by:
receiving first information for the metric after a release time based on the release of the second instance of the item with a second feature and the first feature;
receiving second information for the metric based on the release time of the second instance of the item with the second feature before the release time; and
estimating a third change in the metric for the second feature and the first feature before the release time based on the first information and the second information, wherein the third change is used to determine the first change.

7. The method of claim 6, wherein estimating the third change in the metric for the second feature and the first feature before the release time comprises:
generating a model based on the release of the second instance of the item with the first feature and the second feature after the release time; and
estimating third information for the metric before the release time based on the release of the second instance of the item with the first feature and the second feature.

8. The method of claim 7, wherein estimating the third change in the metric for the second feature and the first feature before the release time comprises:
using a difference between the third information and the first information to estimate the third change in the metric before the release time.

9. The method of claim 1, wherein selecting the second instance of the item from the second instances of the item based on the relationship to the first instance of the item comprises:
using a similarity in a characteristic of the second instance of the item and the first instance of the item to select the second instance of the item.

10. The method of claim 1, wherein estimating the second change in the metric for the first instance of the item comprises:
applying the first change to a value for the metric to generate the second change.

11. The method of claim 1, wherein estimating the second change in the metric for the first instance of the item comprises:
estimating an effect on the metric for a language and a country;
determining a first value for the metric based on the country; and
determining a second value for the effect by country and the language by applying the effect on the metric to the first value.

12. The method of claim 11, wherein estimating the second change in the metric for the first instance of the item comprises:
estimating the effect by language based on multiple second values for the effect from multiple countries for the language.

13. The method of claim 1, further comprising:
generating ranking scores for multiple features; and
ranking the multiple features based on respective ranking scores.

14. The method of claim 1, further comprising:
generating ranking scores for multiple languages, wherein the ranking scores rank an effect on the metric if the language is released for the first instance of the item.

15. The method of claim 1, wherein use of the feature cannot be determined based on use of the item for the second instances of the item.

16. The method of claim 1, wherein the features comprise different methods of engaging with the item.

17. The method of claim 1, wherein the item comprises content that is consumable by a user account.

18. A non-transitory computer-readable storage medium having stored thereon computer executable instructions, which when executed by a computing device, cause the computing device to be operable for:
receiving a first instance of the item;
receiving information for changes in a metric based on a delayed release time of a feature for second instances of the item after the second instances of the item were released;
selecting a second instance of the item from the second instances of the item based on a relationship to the first instance of the item;
estimating a second change in the metric for the first instance of the item based on a first change in the metric from the second instance of the item that is selected; and
generating a ranking score for the feature if the feature is released for the first instance of the item based on the second change in the metric.

19. The non-transitory computer-readable storage medium of claim 17, wherein:
the first instance of the item is item that has not already been released, and the second change in the metric is based on releasing the feature on an initial release of the first instance of the item.

20. An apparatus comprising:
one or more computer processors; and
a computer-readable storage medium comprising instructions for controlling the one or more computer processors to be operable for:
receiving a first instance of the item;
receiving information for changes in a metric based on a delayed release time of a feature for second instances of the item after the second instances of the item were released;
selecting a second instance of the item from the second instances of the item based on a relationship to the first instance of the item;
estimating a second change in the metric for the first instance of the item based on a first change in the metric from the second instance of the item that is selected; and
generating a ranking score for the feature if the feature is released for the first instance of the item based on the second change in the metric.
